(19) United States
(12) Patent Application Publication
(10) Pub. No.: US 2003/0026102 A1
(43) Pub. Date: Feb. 6, 2003

(54) Full cut-off high-mounted outdoor lighting system

(76) Inventor: Alex Francisco Galia, Phoenix, AZ (US)

Correspondence Address: STEVEN THRASHER, 391 SANDHILL DRIVE, RICHARDSON, TX, 75080, US

(21) Appl. No.: 09/921,800

(22) Filed: Aug. 6, 2001

(51) Int. Cl. F21S 8/08

(52) U.S. Cl. 362/431; 362/249; 362/414; 362/145

(57) ABSTRACT

The invention is an illumination assembly for illuminating a large outdoor playing field with zero candela intensity at an angle of ninety degrees above nadir. The invention includes a support-receiving portion, a luminaire coupled to the support wherein each luminaire achieves full cut-off, and wherein each luminaire is coupled to the support in a way that the illumination assembly achieves full cut-off. The invention is also a method of enabling the reduction of light pollution in an outdoor environment by using at least one full cut-off luminaire. The invention is also embodied as a lighting system for illuminating a large outdoor playing field with zero candela intensity at an angle of ninety degrees above nadir, using a plurality of full cut-off illumination assemblies placed in predetermined locations about the playing field.

### TECHNICAL FIELD

Generally, the invention relates to the field of illumination, and, more specifically, the invention relates to systems, methods, and devices for illuminating outdoor playing fields.

### STATEMENT OF A PROBLEM ADDRESSED BY THIS INVENTION

Since the early days of night baseball, outdoor lighting has allowed persons to enjoy leisure activities in the evening. For example, the lighting of sports fields has allowed the evening pursuit of some of the world's most popular sports. For example, Monday night football is now one network's most watched program. In addition, evening baseball games and night soccer matches are common on both a professional and recreational level. Thus, the advent of night sporting events has had revenue benefits for networks and sporting associations, entertainment benefits for observers, and health benefits for participants. Nighttime sporting events have been of particular benefit for those persons who once had to pursue these activities in the heat of a summer sun. However, the use of outdoor lighting at sporting events, concerts and other activities has raised several criticisms.

Most criticisms of outdoor lighting centers on the amount of energy it uses and on the glare that the outdoor lights produce. The energy use associated with powering lights for nighttime sporting events has resulted in the banning of such events in times of energy crises, such as the 2000 and 2001 energy crises in California. In addition the glare (also called “spill” or “light pollution”) from outdoor lighting has raised complaints where residents close to the lights wish to try to sleep before the lights are turned off. Also, the glare is obtrusive to drivers who view the glare where lit fields are close to roadways. Furthermore, residents and spectators often find this glare just plain annoying.

Accordingly, to overcome these and other disadvantages associated with existing methods of lighting sports fields, it would be advantageous to provide means for reducing the cost and energy consumption associated with the operation and installation of outdoor lighting, and for reducing the glare and spill associated with outdoor lighting.

### SELECTED OVERVIEW OF SELECTED EMBODIMENTS

The invention provides technical advantages as systems, methods, and devices for achieving full cut-off lighting in large outdoor playing fields. In one embodiment the invention is an illumination assembly for illuminating a large outdoor playing field with zero candela intensity at an angle of ninety degrees above nadir. The invention includes a support-receiving portion, a luminaire coupled to a support wherein the luminaire achieves full cut-off and wherein the luminaire is coupled to the support in a way that the illumination assembly achieves full cut-off. The invention is also a method of enabling the reduction of light pollution in an outdoor environment by using at least one full cut-off luminaire. In addition, the invention is embodied as a lighting system for illuminating a large outdoor playing field with zero candela intensity at an angle of ninety degrees above nadir, using a plurality of full cut-off illumination assemblies placed in predetermined locations about the playing field.

Thus embodied, the invention provides numerous advantages. For example, the invention places more light on a field. Thus, in one embodiment, the invention reduces the number of supports required to completely light a field, and it follows that installation costs and operational costs will also be lower. The invention also reduces glare and “spill” light. Accordingly, the invention increases the ability of providers of sports fields to comply with local dark-sky ordinances. Since glare is reduced, there should be less opposition to the lighting of sports fields when the local residents are properly educated. When properly arranged, the use of the invention will also allow for the dramatic reduction of the glare which causes outfielders in baseball or softball to loose a pop-fly ball in the lights, and miss-judge its location.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Accordingly, the invention should be read as being limited only by the claims.

### BRIEF DESCRIPTION OF THE DRAWINGS

Various aspects of the invention, as well as an embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows a mounting of a luminaire assembly that provides emphasis to referenced angles;

FIG. 2 illustrates two luminaire assemblies having a first luminaire assembly and a second luminaire assembly to show various cut-off, and non cut-off angles;

FIG. 3 is a top-view of a full cutoff luminaire;

FIG. 4 is a side-view of a full cutoff luminaire;

FIG. 5a shows a bottom view of a multi-luminaire illumination assembly; and

FIG. 5b illustrates a multi-lamp luminaire.

### AN EXEMPLARY EMBODIMENT OF A BEST MODE

The use of full cut-off lighting provides the previously unknown technical advantages of reducing the number of supports required to provide complete lighting to a field, relative to other low-glare systems, thus lowering installation costs and operational costs. Because the invention uses full cut-off lighting, glare and “spill” light are reduced. Accordingly, the invention increases the ability of providers of sports fields to comply with local dark-sky ordinances. The dramatic reduction of glare also enhances the quality of the sports performance. Accordingly, the invention provides an illumination assembly for illuminating a large outdoor playing field with zero candela intensity at an angle of ninety degrees above nadir by using full cut-off luminaries. The invention also incorporates a method of using full cutoff luminaries to reduce light pollution. Furthermore, the invention is embodied as a lighting system for illuminating a large outdoor playing field with zero candela intensity at an angle of ninety degrees above nadir, using a plurality of full cut-off illumination assemblies placed in predetermined locations about the playing field.

Interpretative Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the claims section.

Description of the Figures

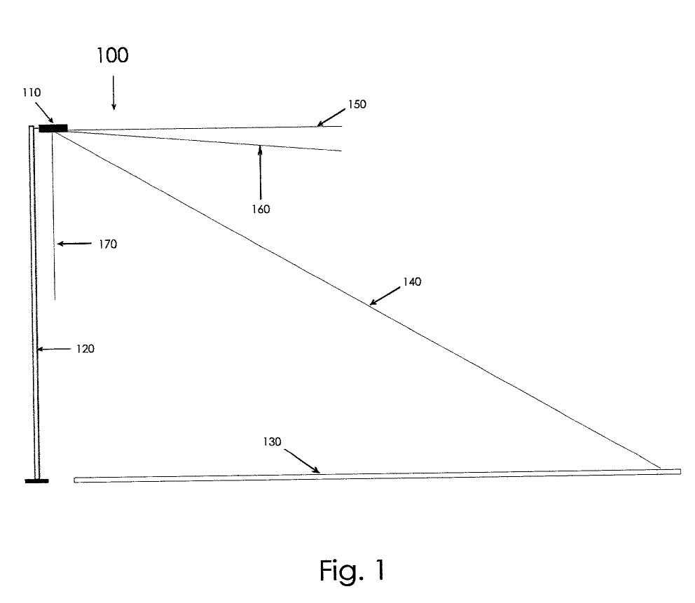

Understanding of the invention may be achieved by reference to the drawings. FIG. 1 shows a mounting of an illumination assembly 100 (also known as an illumination arrangement) that provides emphasis to referenced angles. In general, the illumination assembly 100 provides a luminaire (or luminaires) 110 coupled to a support 120. The support 120 may be any supporting means such as a pole, a building, or another structure. Preferably, the luminaire is mounted at about 60 feet, but could be mounted between about 40 feet and about 120 high, and as high as about 160 feet above a target area, for example, when lighting college sports fields. The luminaire 110 maintains lamps (not shown) that produce light and throw the light upon a target area 130. The target area is preferably a field, such as a sports field, for example. Preferably, the illumination assembly is configurable to light a football field, a soccer field, a baseball field or a softball field (collectively referred to as “ball fields”), by being placed about the periphery of such a field. To light a sports field, it will take a plurality of illumination assemblies mounted about the periphery of the field.

Nadir 170 is the angle of 0-degrees directly below the luminaire. The horizontal plane of the luminaire is 90-degrees. The luminaire is a full cutoff luminaire, meaning that the luminaire has a light distribution that produces a zero candela intensity at an angle of 90 degrees above nadir, which is illustrated by the horizontal line 150 (also called the horizontal plane), and the candela per 1000 lamp lumens does not exceed 100 (or, 10%) at a vertical angle of 80 degrees above nadir (this applies to all lateral angles around the luminaire). Preferably, the luminaire produces zero candela intensity at even an angle of 85 degrees above nadir, which is illustrated by the preferred line 160. In one embodiment, the invention cast the main beam intensity below the 65-degree plane 140.

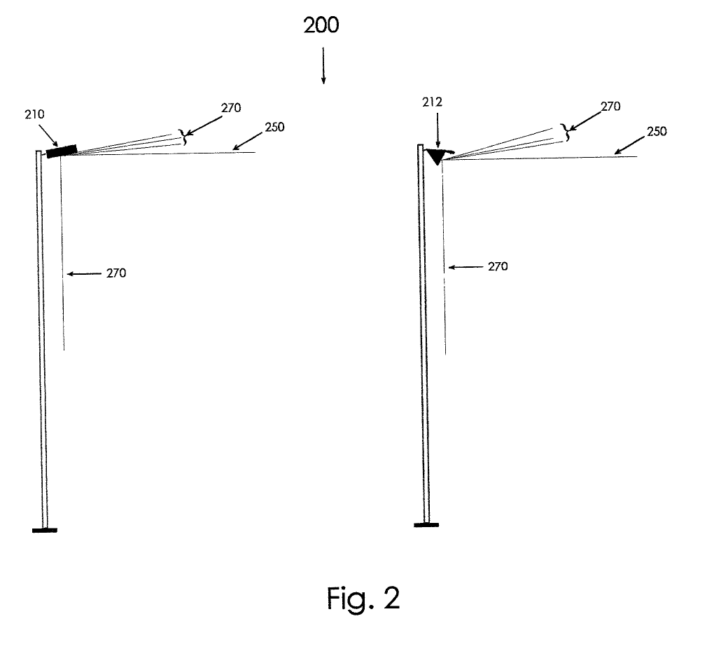

Appreciation of the invention can be realized by examining poor light casting. FIG. 2 illustrates luminaire assemblies 200 having a first luminaire 210 and a second luminaire 212 to show various cutoff angles. Nadir is 270. In FIG. 2 it is shown that the luminaries 210, 212 throw light above a horizontal plane 250. This is considered cutoff lighting, in that lamp light distribution has candela per 1000 lamp lumens that does not exceed 25 (2.5%) at an angle of 90 degrees above nadir, and 100 (10%) at a vertical angle of 80 degrees above nadir, or it is considered non-cutoff lighting in that the luminaire light distribution has no candela limitation in the zone above the horizontal plane 250. This applies to lateral angles around the luminaire. One disadvantage of cutoff luminaries or non-cutoff luminaires is that they still produce glare and spill light due to the casting of light 270 above the horizontal plane. The luminaries 210, 212, may be non-cutoff floodlights, cutoff luminaries, or improperly mounted cutoff luminaires, or improperly mounted full cutoff luminaries.

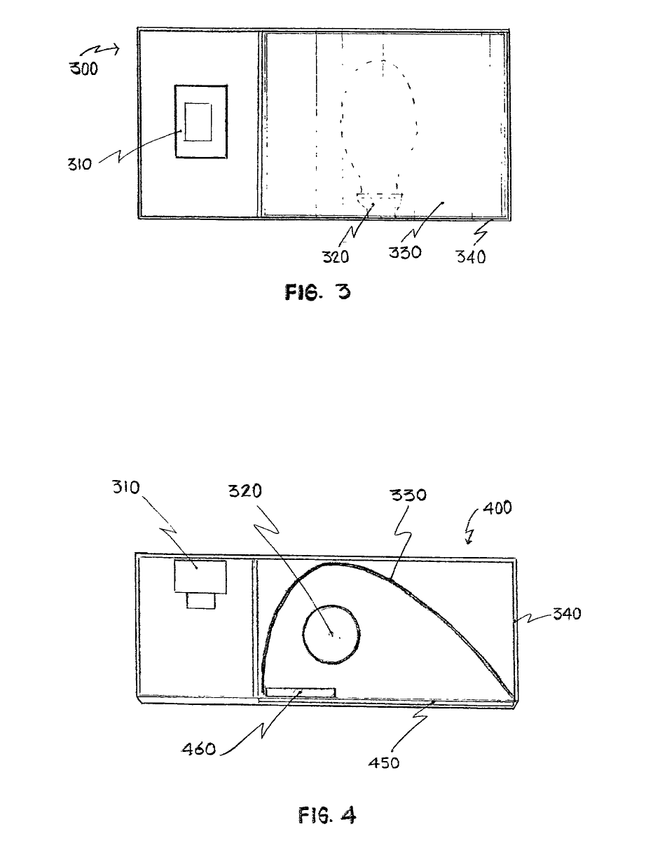

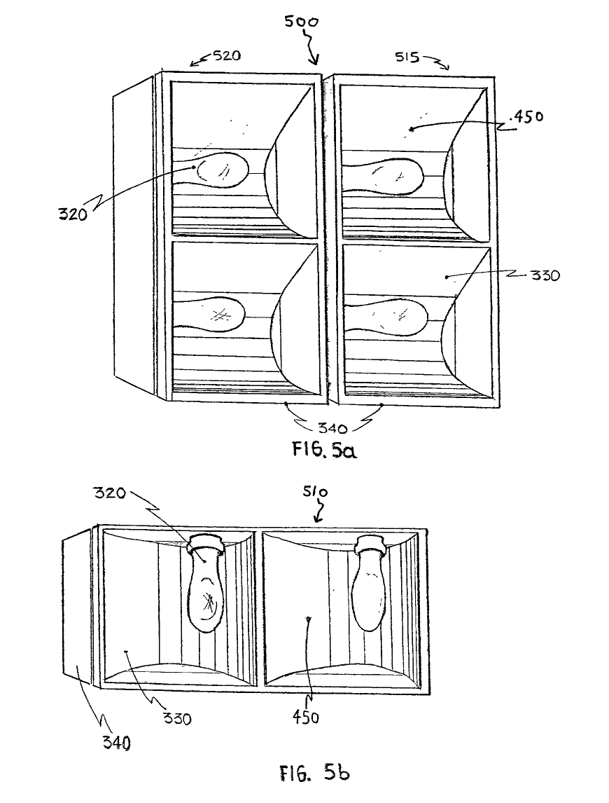

Implementation of a full cutoff illumination assembly is preferably achieved with full cutoff luminaries. FIG. 3 is a top-view of a full cutoff luminaire 300, while FIG. 4 is a side-view of a full cutoff luminaire 400. FIGS. 5a and 5b each illustrate two embodiments of multi-lamp luminaries, while FIG. 5a in particular shows a multi-luminaire illumination assembly. Each of the devices 300, 400, 500, 510 is preferably coupled to a support via a support-receiving portion, and, as shown more than one luminaire may be coupled to a single support.

The full cutoff luminaire 300 and 400 each show an included a ballast/transformer 310 for converting power in a luminaire to the type of power needed by a lamp 320. It should be understood that one advantage of the invention is that a ballast may be located in a separate enclosure, apart from a luminaire. In addition, each of the devices 300, 400, 500, 510 provides a lamp housing 340 with a lens 450 mounted thereto. The combination of a lamp (which could be any light-emitting device), a reflector, and a lens is called an optical assembly.

A reflector 330 is a preferred means for casting light in a desired location of a target area. In a preferred embodiment, an illumination assembly 500 includes a second luminaire 520 mounted beside a first luminaire 515 within the same illumination assembly 500. Furthermore, referring again to FIG. 4, in a preferred embodiment, the invention provides a light-blocking shield 460 as a preferred means for preventing spill light and glare.

The optical assemblies of the devices 300, 400, 500, 510 preferably have a main candle power distribution in about the sixty-degree plane, and do not emit light above the eighty-five degree plane. This allows the luminaries to be coupled to the support at an angle above the horizontal plane. In addition, the devices 300, 400, 500, 510 maintain a main beam intensity in about the sixty-degree plane.

FIG. 5a shows a bottom view of a multi-luminaire illumination assembly 500. The multi-luminaire illumination assembly 500 has a first luminaire 515 and a second luminaire 520 disposed adjacent to the first luminaire 515. Although two luminaries 515, 520 are illustrated, it should be understood that any number of luminaries may be disposed adjacent to each other, in a side-by-side fashion, one above the other, or diagonally across from each other.

FIG. 5b illustrates the bottom view of a multi-lamp luminaire 510. The multi-lamp luminaire 510 has two lamps disposed horizontally one behind the other. Although two lamps are illustrated, it should be understood that any number of lamps may be disposed in any configuration, and in conjunction with reflectors and/or light blocking shields to achieve a desired light distribution.

The invention may be embodied as methods of lamp assembly installation, and may include acts that promote the business of lamp assembly installation. For example, one method may incorporate the promotion of full cutoff lamp assemblies. Another method contemplates coordination with a local government or other organizations to show compliance with a light (or dark sky) ordinance. Preferably, the methods include installing the lamp assemblies about a sports field.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

I claim:

1. A lighting system for illuminating a large outdoor playing field with zero candela intensity at an angle of ninety degrees above nadir, comprising:
a plurality of illumination assemblies placed in predetermined locations about the playing field, each illumination assembly comprising a support and a luminaire coupled to the support;
wherein each luminaire achieves full cut-off; and
wherein each luminaire is coupled to a support in a way that the plurality of illumination assemblies, when placed in the predetermined locations, achieve full cut-off.

2. The lighting system of claim 1 wherein the outdoor playing field comprises at least a football field.

3. The lighting system of claim 1 wherein the outdoor playing field comprises at least a soccer field.

4. The lighting system of claim 1 wherein the outdoor playing field comprises at least a ball field.

5. The lighting system of claim 1 wherein the illumination assemblies comprise a plurality of luminaries.

6. The lighting system of claim 5 wherein a first luminaire is mounted behind a second luminaire.

7. The lighting system of claim 1 wherein the luminaire is mounted at a height of at least 40 feet.

8. The lighting system of claim 1 wherein the lighting system is placed about a periphery of the playing field.

9. A method of enabling the reduction of light pollution in an outdoor environment for enabling compliance with local ordinances, comprising:
mounting at least one full cut-off luminaire about an outdoor area to be lighted, the full cut-off luminaire to light the outdoor area; and
removing all non full cut-off luminaries that once lit the outdoor area from the outdoor area to be lighted.

10. The method of claim 9 further comprising turning on a full cut-off luminaire.

11. The method of claim 9 wherein the outdoor area is the playing surface of a large sporting field.

12. The method of claim 9 further comprising the act of automatically registering with a local government to show compliance with a local light ordinance.

13. The method of claim 9 further comprising the act of automatically canvassing a local community to show that installation of full cut-off lighting will dramatically reduce spill light.

14. An illumination assembly for illuminating a large outdoor playing field with zero candela intensity at an angle of ninety degrees above nadir, comprising:
a support-receiving portion;
a luminaire coupled to the support; and
wherein each luminaire is coupled to the support in a way that the illumination assembly achieves full cut-off.

15. The illumination assembly of claim 14 wherein each luminaire achieves full cut-off.

16. The illumination assembly of claim 14 wherein the luminaire comprises an optical assembly having a main candle power distribution in about the sixty-degree plane.

17. The illumination assembly of claim 15 wherein the luminaire does not emit light above the eighty-five degree plane.

18. The illumination assembly of claim 15 wherein the luminaire maintains a main beam intensity in the sixty-degree plain.

19. The illumination assembly of claim 15 wherein the luminaire is coupled to the support at an angle above the horizontal plane.

20. The illumination assembly of claim 14 further comprising a second luminaire coupled to the support.

21. The illumination assembly of claim 17 wherein the illumination assembly comprises a plurality of luminaries.

22. The illumination assembly of claim 14 wherein the luminaire further comprises at least one light-blocking shield.
